(19) United States
(12) Patent Application Publication
(10) Pub. No.: US 2007/0240211 A1
(43) Pub. Date: Oct. 11, 2007

(54) Authentication method, authentication apparatus and authentication program storage medium

(75) Inventors: Hiroyuki Kosaka, Kawasaki (JP); Osamu Funayama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/489,481

(22) Filed: Jul. 20, 2006

(30) Foreign Application Priority Data
Apr. 10, 2006 (JP) 2006-107909

(51) Int. Cl. H04L 9/32

(52) U.S. Cl. 726/20

(57) ABSTRACT

In an authentication method for two programs which are executed when it is confirmed by authentication that a user is a valid user, pre-registered first reference data is acquired when authentication is performed for a first program to be activated earlier, and authentication data inputted by a user when the authentication for the first program is performed is acquired. Authentication for execution of the first program is performed with the use of the first reference data and the authentication data. Pre-registered second reference data is acquired when authentication is performed for a second program to be activated later, and authentication for execution of the second program is performed with the use of the second reference data and the authentication data already acquired at the authentication for the first program.

### BACKGROUND OF THE INVENTION

1. Field of the Invention

The present invention relates to an authentication method and authentication apparatus for two programs which are executed when it is confirmed by authentication that a user is a valid user, and an authentication program storage medium storing an authentication program which is executed in an information processing apparatus for executing programs and causes the information processing apparatus to operate as the authentication apparatus.

2. Description of the Related Art

The robustness of a security function is more and more important to prevent the risk that an information processing apparatus represented by a personal computer (hereinafter abbreviated as “PC”) is unauthorizedly used, and thereby information inside the PC unauthorizedly outflows. Conventionally, authentication by password has been widely adopted as a security function. However, authentication by biological information, such as authentication by checking fingerprint information or finger information is increasingly spreading in order to improve a security function (see Japanese Patent Laid-Open No. 09-330140 and Japanese Patent Laid-Open No. 10-198453). Especially, as a security function for a PC, a lock function by a BIOS (Basic Input/Output System), a lock function operated when an OS (operating system) is activated, and the like are widely used, and authentication by biological information is also used for these lock functions.

Conventionally, a more robust security function has been realized by a lock function being used by both of a BIOS and an OS. However, it is troublesome that it is necessary to perform authentication work twice in order to release the lock.

In order to reduce this troublesomeness, it has been devised to raise a flag on memory in the case of success of authentication for the BIOS so that authentication only by checking the flag is sufficient for authentication for the OS. In this case, since a user is required to perform authentication work only once, the troublesomeness is reduced. However, the security performance is degraded. For example, in the case where the authentication mechanism of only confirming a flag is analyzed by a third person or in the case where the third person has obtained a PC with the same specifications, if a hard disk drive (HDD) in which an OS and important information are stored is stolen and used by the third person, it is possible for the third person to connect the HDD to that other PC and logon the OS in the HDD by spoofing as a valid user, so that the important information may be stolen. This is because authentication is performed only based on whether or not there is a flag, and authentication is successful with a PC with the same specifications if there is a flag.

### SUMMARY OF THE INVENTION

The present invention has been made in view of the above circumstances and provides an authentication method and an authentication apparatus which reduce troublesomeness of authentication work while keeping security robustness, and an authentication program storage medium which stores an authentication program for causing an information processing apparatus such as a PC to operate as such an authentication apparatus.

The authentication method of the present invention is an authentication method for performing authentication for two programs which are executed when it is confirmed by authentication that a user is a valid user, the method including:

a first step which, when authentication is performed for a first program to be activated earlier between the two programs, acquires pre-registered first reference data which is to be the basis of authentication for the first program as well as acquiring authentication data inputted by the user when authentication is performed for the first program, performs authentication for execution of the first program using the first reference data and the authentication data, and causes the first program to be executed if the user is a valid user; and

a second step which, when authentication is performed for a second program to be activated later between the two programs, acquires pre-registered second reference data which is to be the basis of authentication for the second program, performs authentication for execution of the second program using the second reference data and the authentication data acquired by the first step, and causes the second program to be executed if the user is a valid user.

According to the authentication method of the present invention, the same authentication data is used for authentication for each of a first program (for example, a BIOS) and a second program (for example, an OS) so that a user has to perform authentication work only once, and troublesomeness is reduced thereby. Furthermore, authentication is performed not only for the first program but also for the second program. Therefore, for example, in the example of the case where an HDD is stolen, the reference data to be checked against the authentication data does not correspond to the authentication data. Thus, the security performance is kept high in comparison with the case of simply raising a flag.

Here, the first and second steps may acquire the first and second reference data which are the same data.

Since the authentication data is used in common, it is preferable that the reference data is also used in common. Even in this case, the security performance is kept high, and it is possible to avoid the risk of different authentication results being caused between authentication for the first program and authentication for the second program in authentication using biological information, for example.

In the authentication method of the present invention, it is preferable that the first step acquires the first reference data by reading the first reference data stored in a first storage place from the first storage place; and the second step acquires the second reference data by reading the second reference data stored in a second storage place different from the first storage place, from the second storage place.

If the first and second programs are programs executed on different platforms, for example, like a BIOS and an OS, authentication for each program is smoothly performed by storing the reference data in a corresponding storage place which can be used by each platform.

In this case, it is preferable that the authentication method includes a third step to be executed before the first and second steps which receives reference data to be used as both of the first and second reference data, which is inputted by a user operation, and causes both of first and second storage places different from each other to store the reference data; wherein

the first step acquires the first reference data by reading the first reference data stored in the first storage place from the first storage place, and the second step acquires the second reference data by reading the second reference data which is the same as the first reference data and which is stored in the second storage place, from the second storage place.

It is preferable that the authentication method of the present invention provides an option of omitting authentication processing and causing each of the first and second programs to be executed; wherein

when the option is set for the first program, the first step is skipped;

when the option is set for the second program, the second step is skipped; and

when the option is set only for the first program, the second step acquires the authentication data inputted by the user when authentication is performed for the second program and uses the authentication data.

Thereby, it is possible for the user to arbitrarily determine to cause authentication to be performed only for one of the first and second programs or skip authentication for both programs.

In the authentication method of the present invention, biological authentication data can be preferably used as the first reference data, the second reference data and the authentication data.

In the authentication method of the present invention, the first and second programs may be a BIOS and an OS, respectively.

However, the authentication method of the present invention can be applied to authentication for any two programs which are sequentially activated and each of which requires authentication, in addition to the combination of a BIOS and an OS.

The authentication apparatus of the present invention is an authentication apparatus for performing authentication for two programs which are executed in an information processing apparatus for executing programs, such as a PC, the authentication apparatus having:

a reference data acquisition section which acquires pre-registered first reference data which is to be the basis of authentication for a first program to be activated earlier between the two programs and pre-registered second reference data to be the basis of authentication for a second program to be activated later between the two programs;

an authentication data acquisition section which acquires authentication data generated by a user operation;

a first authentication section which causes the reference data acquisition section to acquire the first reference data as well as causing the authentication data acquisition section to acquire the authentication data, performs authentication for execution of the first program using the first reference data and the authentication data, and causes the first program to be executed when it is confirmed that a user is a valid user; and

a second authentication section which causes the reference data acquisition section to acquire the second reference data, performs authentication for execution of the second program using the second reference data and the authentication data already acquired by the authentication data acquisition section, and causes the second program to be executed when it is confirmed that the user is a valid user.

Here, it is preferable that the authentication apparatus of the present invention has a first storage section which stores the first reference data and a second storage section which stores the second reference data, wherein

the reference data acquisition section acquires the first reference data by reading the first reference data from the first storage section and acquires the second reference data by reading the second reference data from the second storage section.

In this case, it is preferable that the authentication apparatus is provided with a reference data registration section which receives reference data to be used as both of the first and second reference data, the reference data being generated by a user operation, and causes the reference data to be stored in both of the first and second storage sections.

It is preferable that the authentication apparatus provides an option of omitting authentication processing and causing each of the first and second programs to be executed; wherein

when the option is set for the first program, the first authentication section skips authentication processing and causes the first program to be executed;

when the option is set for the second program, the second authentication section skips authentication processing and causes the second program to be executed; and

when the option is set only for the first program, the second authentication section causes the reference data acquisition section to acquire the second reference data as well as causing the authentication data acquisition section to acquire the authentication data, performs authentication for execution of the second program using the second reference data and the authentication data, and causes the second program to be executed when it is confirmed that the user is a valid user.

In the authentication apparatus of the present invention also, it is preferable that the first reference data, the second reference data and the authentication data are biological authentication data, similarly to the authentication method of the present invention, and the first program and the second program may be a BIOS and an OS, respectively.

The authentication program storage medium of the present invention is an authentication program storage medium in which an authentication program is stored, the program being executed in an information processing apparatus for executing programs, such as a PC, and causing the information processing apparatus to operate as an authentication apparatus for performing authentication for two programs which are executed in the information processing apparatus, and causing the authentication information to operate as an authentication apparatus having:

a reference data acquisition section which acquires pre-registered first reference data which is to be the basis of authentication for a first program to be activated earlier between the two programs and pre-registered second reference data to be the basis of authentication for a second program to be activated later between the two programs;

an authentication data acquisition section which acquires authentication data generated by a user operation;

a first authentication section which causes the reference data acquisition section to acquire the first reference data as well as causing the authentication data acquisition section to acquire the authentication data, performs authentication for execution of the first program using the first reference data and the authentication data, and causes the first program to be executed when it is confirmed that a user is a valid user; and

a second authentication section which causes the reference data acquisition section to acquire the second reference data, performs authentication for execution of the second program using the second reference data and the authentication data already acquired by the authentication data acquisition section, and causes the second program to be executed when it is confirmed that the user is a valid user.

The authentication program storage medium includes all aspects corresponding to the various aspects of the authentication apparatus.

In the authentication program of the present invention, respective program parts may be different programs. That is, the first authentication section and the second authentication section may be incorporated in different programs.

According to the present invention described above, troublesomeness of authentication work can be reduced without degrading security performance.

### BRIEF DESCRIPTION OF THE DRAWINGS

FIG. 1 is a schematic diagram of a personal computer (PC);

FIG. 2 is an internal block diagram of the PC the external view of which is shown in FIG. 1;

FIG. 3 is a flowchart of a fingerprint registration program for registering a fingerprint with the PC shown in FIGS. 1 and 2;

FIG. 4 shows an image to be displayed by execution of the fingerprint registration program;

FIG. 5 is a flowchart showing processing to be performed at authentication; and

FIG. 6 shows an example of separate storage places for reference data.

### DETAILED DESCRIPTION OF THE INVENTION

An embodiment of the present invention will be described below.

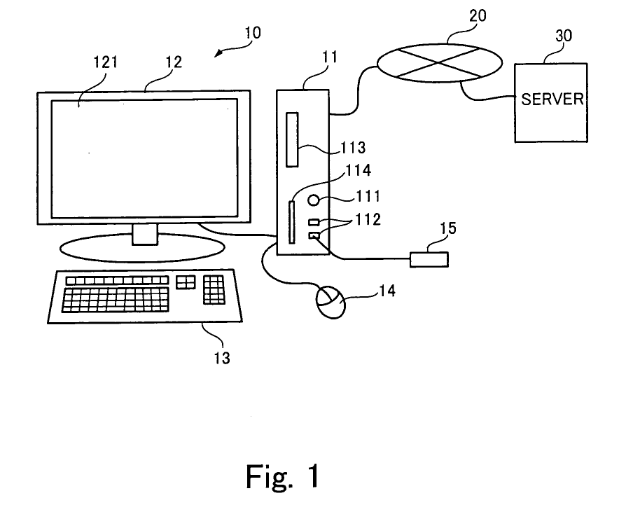

FIG. 1 is a schematic diagram of a personal computer (PC) 10.

The PC 10 shown in FIG. 1 also operates as an embodiment of the authentication apparatus of the present invention by a program to be described later being executed in the PC 10.

The PC 10 is provided with a PC main device 11 in which a CPU, a memory and the like are included, a display device 12 which displays an image on a display screen 121 in response to an instruction from the PC main device 11, a keyboard 13 which gives various instructions and information to the PC main device 11 by being operated by a user, a mouse 14 which moves a cursor on the display screen 121 of the display device 12 and gives an instruction corresponding to an icon or the like on the display screen 121, on which the cursor is placed, by a button being operated, and a fingerprint sensor 15 for detecting a user' s fingerprint and acquiring fingerprint data into the PC main device 11.

The PC main device 11 is provided with a power button 111 for giving an instruction to power on the PC 10, two USB connectors 112 in accordance with the USB (Universal Serial Bus) standard, a CD/DVD mounting slot 113 through which a CD or a DVD is mounted, and an FD mounting slot 114 through which an FD (floppy disk (registered trademark)) is mounted, as components shown in FIG. 1. The PC main device 11 is connected to a server 30 via a LAN (local area network) line 20.

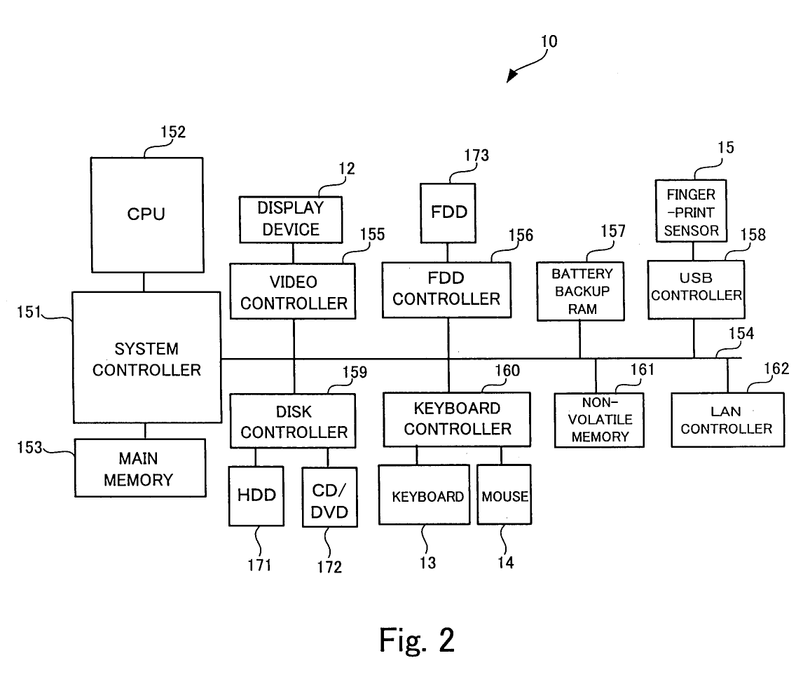

FIG. 2 is an internal block diagram of the PC the external view of which is shown in FIG. 1.

To a system controller 151, a CPU 152 and a main memory 153 are connected. Furthermore, a video controller 155, an FDD controller 156, a battery backup RAM 157, a USB controller 158, a disk controller 159, a keyboard controller 160, a non-volatile memory 161 and a LAN controller 162 are also connected via a bus 154.

The system controller 151 is a component responsible for controlling the entire system. The CPU 152 is a component responsible for executing a program developed on the main memory 153. The main memory 153 is a memory on which a program read from a hard disk (HD) included in a hard disk drive (HDD) 171 to be described later is developed to be executed by the CPU 152 and which is used as a work area for execution of the program.

The video controller 155 is responsible for displaying an image on the display device 12, which is also shown in FIG. 1, in response to an instruction from the CPU 152 via the system controller 151. The FDD controller 156 is responsible for controlling an FD drive (FDD) 173 which is responsible for accessing an FD (floppy disk (registered trademark) mounted through the FD mounting slot 114 shown in FIG. 1. The battery backup RAM 157 is a memory for storing various setting information about this PC 10. The USB controller 158 is a component responsible for communication control in accordance with the USB standard. The USB controller 158 is provided with the USB connectors 112 shown in FIG. 1, and the fingerprint sensor 15 is connected via the USB connector 112.

The disk controller 159 is a component which accesses the hard disk drive (HDD) 171 included in the PC main device 11 (see FIG. 1) or a CD/DVD 172 mounted through the CD/DVD mounting slot 113 shown in FIG. 1. The HDD 171 includes a hard disk (HD), and in the HD, there are stored an OS, various application programs and the like. These programs are read under the control of the disk controller 159 which has received an instruction from the system controller 151, and developed on the main memory 153 to be executed by the CPU 152.

A CD/DVD in which various programs and the like are stored is mounted in the CD/DVD drive 172 and accessed under the control of the disk controller 159, and the programs and the like stored in the CD/DVD are uploaded to the PC 10. They can also be stored in the HD included in the HDD 171.

Furthermore, the keyboard controller 160 is responsible for detecting an operation of the keyboard 13 or the mouse 14 which are also shown in FIG. 1 to communicate a result of the detection to the system controller 151.

In the non-volatile memory 161, there is stored a program referred to as BIOS (Basic Input/Output System) which is executed first after the PC 10 is powered on.

The LAN controller 162 is a component which communicates with the server 30 via the LAN line 20.

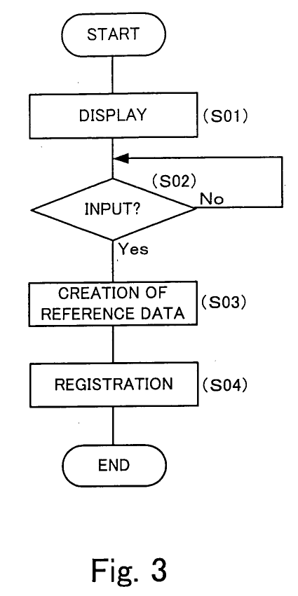

FIG. 3 is a flowchart of a fingerprint registration program for registering a fingerprint with the PC 10 shown in FIGS. 1 and 2, and FIG. 4 shows an image to be displayed by execution of the fingerprint registration program.

This fingerprint registration program is one of application programs operating on the OS.

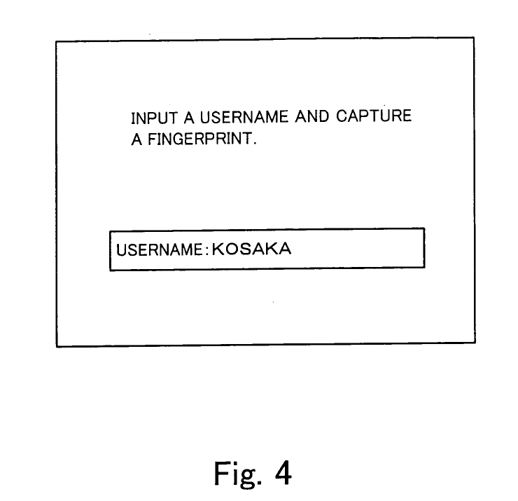

When this fingerprint registration program is activated, an image shown in FIG. 4 is displayed on the display screen 121 of the display device 12 (see FIG. 1) (step S01), and the process waits for an input by a user operation (step S02).

The user inputs a username on the displayed image by operating the keyboard (FIG. 4 shows an example in which “KOSAKA” is already inputted), and places his finger on the fingerprint sensor 15 (see FIGS. 1 and 2) to have a fingerprint read.

Thus, when it is determined at step S02 that there is an input, reference data to be referred to when authentication is performed is created based on the input data (the username and fingerprint data) (step S03), and the created reference data is registered (step S04).

In this embodiment, this reference data is registered on the non-volatile memory 161 shown in FIG. 2, to be used for authentication processing by the BIOS, and the same reference data as that registered on the non-volatile memory 161 is also registered on the HD included in the HDD 171 shown in FIG. 2, to be used for authentication processing by the OS.

When the reference data is created at step S03, various processings such as extraction of fingerprint data characteristics and encryption are performed. However, these processings themselves are not the aim of this embodiment, and they are widely known techniques. Therefore, detailed description thereof will be omitted here.

Not only registration but also deletion or change of the reference data is performed. However, they also are not the aim of this embodiment, and they are widely known techniques. Therefore, illustration and description thereof will be omitted here.

Furthermore, though authentication processing by password is also performed in this embodiment, registration, deletion, change and the like of a password are not the aim of this embodiment, and they are widely known techniques. Therefore, illustration and description thereof will be omitted.

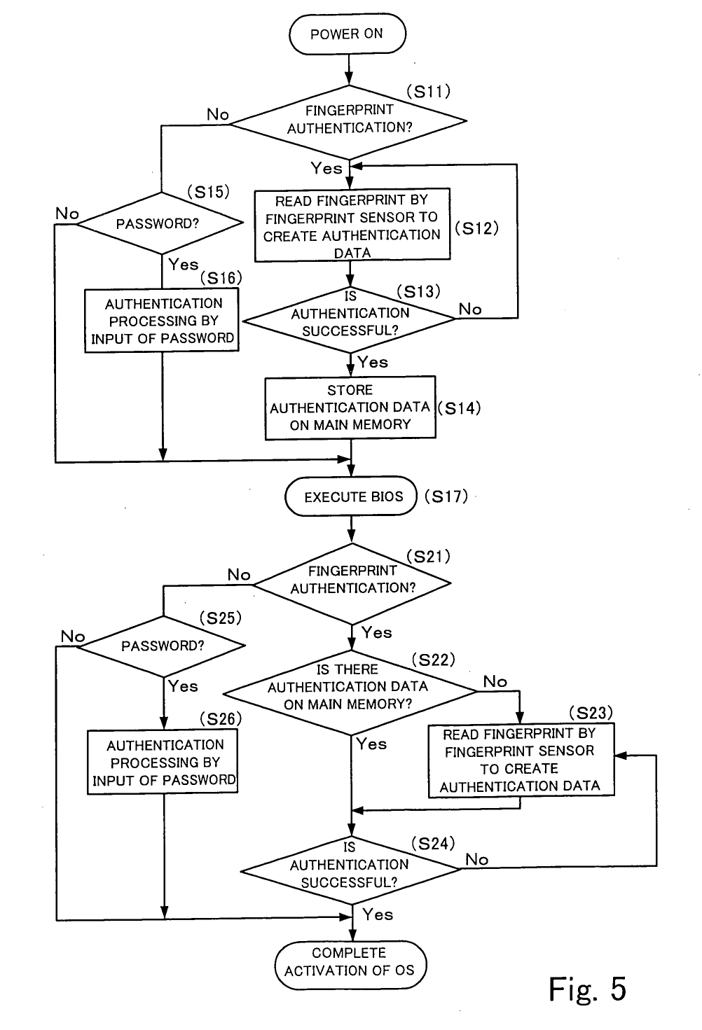

FIG. 5 is a flowchart showing processing performed at authentication.

When the user presses the power button 111 shown in FIG. 1, POST (Power On Self Test) processing by the BIOS is started, and during the POST processing, authentication processing at steps S11 to S16 is performed. In this authentication processing, it is first determined whether or not to perform authentication by fingerprint (step S11). At step S11, if the reference data for the BIOS exists on the non-volatile memory 161 shown in FIG. 2, it is determined that fingerprint authentication is to be performed.

If fingerprint authentication is to be performed, then the process proceeds to step S12, where display for capturing fingerprint data is shown on the display screen to prompt the user to have a fingerprint captured. When the user's fingerprint is read by the fingerprint sensor 15 and authentication data is created, the authentication data and the reference data read from the non-volatile memory 161 are checked against each other. If the data correspond to each other, authentication is successful (step S13). When authentication is not successful, that is, the authentication data does not correspond to the reference data, an authentication error is determined, and the process returns to step 12. The authentication error is informed, and display prompting the user to make an input again is shown. For example, when authentication is not successful even if the authentication processing is repeated ten times, it is displayed that the BIOS cannot be activated because of the authentication failure and the processing stops, though this is omitted in the flowchart in FIG. 5. In this case, in order to restore the processing, the power button 111 is pressed to stop supplying the power once, and then the power button 111 is pressed again to supply the power again.

If it is determined at step S13 that authentication is successful, the process proceeds to step S14, and the authentication data when the authentication is successful and a corresponding username are stored on the main memory 153.

If reference data for fingerprint authentication does not exist on the non-volatile memory 161, and therefore it is determined at step S11 that fingerprint authentication is not to be performed, then the process proceeds to step S15, where it is determined whether or not to perform authentication by password. In this embodiment, whether or not to perform authentication bypass word is determined based on whether or not a password for authentication for the BIOS is stored in the non-volatile memory 161 shown in FIG. 2, similarly to the case of the fingerprint authentication.

If a password for authentication is stored in the non-volatile memory 161, and it is determined that authentication by password is to be performed, then the process proceeds to step S16, where authentication processing by inputting a password is performed. That is, an image for inputting a password is displayed to wait for input of a password, and an inputted password and the password on the non-volatile memory 161 are checked against each other. If the passwords correspond to each other, authentication is successful. If the passwords do not correspond to each other, an authentication error is caused, and the user is prompted to input a password again. If the passwords do not correspond to each other three times, a message indicating that the BIOS cannot be activated because of the authentication failure is displayed and the processing stops, though this is omitted in FIG. 5.

If a password for authentication does not exist on the non-volatile memory 161, and therefore it is determined at step S15 that authentication bypass word is not to be performed, then step S16 for password authentication processing is skipped.

In this way, if authentication by fingerprint or password is successful or if it is determined that neither fingerprint authentication nor password authentication is to be performed (steps S11 and S15), then the process proceeds to step S17, where the main processing of the BIOS is executed. During the processing at step S17, the OS is activated, and the process proceeds to authentication processing for the OS (steps S21 to S26).

At step S21, it is determined whether or not the reference data for the OS exists on the HD included in the HDD 171 shown in FIG. 2, and it is determined that fingerprint authentication is to be performed if the reference data exists.

If fingerprint authentication is to be performed, the process proceeds to step S22, and it is determined whether or not the authentication data created at step S12 and stored at step S14 and a corresponding username, for which authentication for the BIOS is being performed, exist on the main memory 153. If the authentication data and the corresponding username exist on the main memory 153, then the authentication data and reference data corresponding to the username, which is read from the HD included in the HDD 171, are checked against each other to determine whether or not authentication is successful (step S24). Here, the authentication data stored on the main memory 153 is used, the reference data read from the HD is the same as the reference data for the BIOS stored on the non-volatile memory 161, and authentication is successful at step S13. Therefore, authentication is also successful at step S24.

If it is determined at step S22 that the authentication data does not exist on the main memory 153, then the process proceeds to step S23. Here, similarly to step S12, display for capturing fingerprint data similar to that in FIG. 4 is shown, and the user is prompted to input a username and have a fingerprint captured. When a username is inputted on the display screen, the user's fingerprint is read by the fingerprint sensor 15, and authentication data is created, the authentication data and the reference data read from the HD are checked against each other. If the data correspond to each other, authentication is successful (step S24). If authentication is not successful, that is, the authentication data does not correspond to the reference data, an authentication error is caused, and the process returns to step S23. The user is informed of the fact that an authentication error has been caused, and display prompting the user to make an input again is shown. For example, when authentication is not successful even if the authentication processing is repeated ten times, it is displayed that the OS cannot be activated because of the authentication failure and the processing stops, though this is omitted in FIG. 5. In this case, it is possible to power off the PC by selecting one to end the operation of the PC from among options displayed on the display screen.

If the reference data for fingerprint authentication does not exist on the HD, and therefore it is determined at step S21 that fingerprint authentication is not to be performed, then the process proceeds to step S25, where it is determined whether or not to perform authentication by password.

In this embodiment, whether or not to perform authentication by password is determined based on whether or not a password for authentication for the OS is stored in the HD, similarly to the case of the fingerprint authentication.

If the password for authentication is stored in the HD, and it is determined at step S25 that authentication bypass word is to be performed, then the process proceeds to step S26. The processing at step S26 is the same as the processing at step S16 except that a password on the HD is used instead of using a password on the non-volatile memory 161 at step S16. Therefore, any redundant description thereof will be omitted here.

In this way, if authentication by fingerprint or password is successful or if it is determined neither fingerprint authentication nor password authentication is to be performed, then activation of the OS is completed.

In the authentication method of the present invention, the processing of step S17 by the BIOS corresponds to a first program, and the processing performed by the OS after completion of activation of the OS corresponds to a second program. Steps S11 to S14 in FIG. 5 correspond to a first step, and steps S21 to S24 correspond to a second step. The registration processing in FIG. 3 corresponds to a third step in the authentication method of the present invention.

The combination of a section responsible for reading the reference data on the non-volatile memory 161 during step S13 and reading the reference data on the HD during step S24 in the flowchart in FIG. 5 and the PC hardware shown in FIG. 2 (especially the non-volatile memory 161, the HDD 171, the disk controller 159 and the like) corresponds to the reference data acquisition section of the authentication apparatus of the present invention. The combination of steps S12 and S23 in the flowchart in FIG. 5 and the PC hardware (especially the fingerprint sensor 15, the keyboard 13 and the like) corresponds to the authentication data acquisition section of the authentication apparatus of the present invention. The combination of steps S11 to S14 in FIG. 5 and the PC hardware and the combination of steps S21 to S24 and the PC hardware correspond to the first authentication section and the second authentication section of the authentication apparatus of the present invention, respectively. Furthermore, the non-volatile memory 161 and the HD included in the HDD 171 correspond to the first storage section and the second storage section of the authentication apparatus of the present invention, respectively. Furthermore, the combination of the program in FIG. 3 and the PC hardware corresponds to the reference data registration section of the authentication apparatus of the present invention.

Furthermore, the combination of the program in FIG. 3, steps S11 to S14 and steps S21 to S24 shown in FIG. 5 corresponds to an example of the authentication program of the present invention. Thus, in this embodiment, a combination of program parts which are distributedly arranged as multiple programs is considered to be an example of the authentication program according to the present invention.

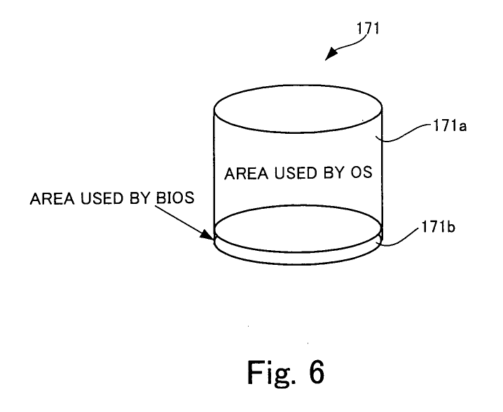

FIG. 6 shows an example of separate storage places for reference data.

In the embodiment described above, the reference data for the BIOS is stored on the non-volatile memory 161, and the reference data for the OS is stored on the HD included in the HDD 171. However, it is also possible to divide the inside of the HD into an area 171a to be used by the OS and an area 171b to be used by the BIOS, store the reference data for the OS in the area 171a, and store the reference data for the BIOS in the area 171b.

In the embodiment described above, description has been made on the assumption that a fingerprint is captured by the fingerprint sensor 15 of the PC, and reference data is created based on the fingerprint (see FIG. 3). However, when the server 30 shown in FIG. 1 is a server which manages PCs in one company, a configuration is also possible in which reference data based on each company member's fingerprint is stored in the server 30, and to each PC, the reference data about a company member who is the user of the PC is downloaded via the LAN line 20.

Here, fingerprint information is used as biological information. However, the present invention is not limited to what handles fingerprint information. What handles authentication by biological information such as a fingertip, a palm vein pattern and a pupil pattern may be possible. Furthermore, the present invention is not limited to what handles biological information, and anything is possible if it performs authentication for the BIOS and the OS based on the same kind of information therein.

Furthermore, description has been made on the case using the BIOS and an OS as an example. However, the present invention is not applied only to the combination of the BIOS and an OS. It is applicable to authentication for two programs which are sequentially activated and each of which requires authentication.

What is claimed is:

1. An authentication method for performing authentication for two programs which are executed when it is confirmed by authentication that a user is a valid user, the method comprising:
a first step which, when authentication is performed for a first program to be activated earlier between the two programs, acquires pre-registered first reference data which is to be the basis of authentication for the first program as well as acquiring authentication data inputted by the user when authentication is performed for the first program, performs authentication for execution of the first program using the first reference data and the authentication data, and causes the first program to be executed if the user is a valid user; and
a second step which, when authentication is performed for a second program to be activated later between the two programs, acquires pre-registered second reference data which is to be the basis of authentication for the second program, performs authentication for execution of the second program using the second reference data and the authentication data acquired by the first step, and causes the second program to be executed if the user is a valid user.

2. The authentication method according to claim 1, wherein the first and second steps acquire the first and second reference data which are the same data.

3. The authentication method according to claim 1, wherein the first step acquires the first reference data by reading the first reference data stored in a first storage place from the first storage place; and
the second step acquires the second reference data by reading the second reference data stored in a second storage place different from the first storage place, from the second storage place.

4. The authentication method according to claim 1, further comprising a third step to be executed before the first and second steps which receives reference data to be used as both of the first and second reference data, which is inputted by a user operation, and causes the reference data to be stored in both of first and second storage places different from each other,
wherein the first step acquires the first reference data by reading the first reference data stored in the first storage place from the first storage place, and
the second step acquires the second reference data by reading the second reference data which is the same as the first reference data and which is stored in the second storage place, from the second storage place.

5. The authentication method according to claim 1, providing an option of omitting authentication processing and causing each of the first and second programs to be executed,
wherein when the option is set for the first program, the first step is skipped,
when the option is set for the second program, the second step is skipped, and
when the option is set only for the first program, the second step acquires the authentication data inputted by the user when authentication is performed for the second program and uses the authentication data.

6. The authentication method according to claim 1, wherein the first and second reference data and the authentication data are biological authentication data.

7. The authentication method according to claim 1, wherein the first program is a BIOS, and the second program is an OS.

8. An authentication apparatus for performing authentication for two programs which are executed in an information processing apparatus for executing programs, the authentication apparatus comprising:
a reference data acquisition section which acquires pre-registered first reference data which is to be the basis of authentication for a first program to be activated earlier between the two programs and pre-registered second reference data to be the basis of authentication for a second program to be activated later between the two programs;
an authentication data acquisition section which acquires authentication data generated by a user operation;
a first authentication section which causes the reference data acquisition section to acquire the first reference data as well as causing the authentication data acquisition section to acquire the authentication data, performs authentication for execution of the first program using the first reference data and the authentication data, and causes the first program to be executed when it is confirmed that a user is a valid user; and
a second authentication section which causes the reference data acquisition section to acquire the second reference data, performs authentication for execution of the second program using the second reference data and the authentication data already acquired by the authentication data acquisition section, and causes the second program to be executed when it is confirmed that the user is a valid user.

9. The authentication apparatus according to claim 8, further comprising:
a first storage section which stores the first reference data; and
a second storage section which stores the second reference data,
wherein the reference data acquisition section acquires the first reference data by reading the first reference data from the first storage section and acquires the second reference data by reading the second reference data from the second storage section.

10. The authentication apparatus according to claim 9, further comprising a reference data registration section which receives reference data to be used as both of the first and second reference data, the reference data being generated by a user operation, and causes both of the first and second storage sections to store the reference data.

11. The authentication apparatus according to claim 8, providing an option of omitting authentication processing and causing each of the first and second programs to be executed,
wherein when the option is set for the first program, the first authentication section skips authentication processing and causes the first program to be executed,
when the option is set for the second program, the second authentication section skips authentication processing and causes the second program to be executed, and
when the option is set only for the first program, the second authentication section causes the reference data acquisition section to acquire the second reference data as well as causing the authentication data acquisition section to acquire the authentication data, performs authentication for execution of the second program using the second reference data and the authentication data, and causes the second program to be executed when it is confirmed that the user is a valid user.

12. The authentication apparatus according to claim 8, wherein the first and second reference data and the authentication data are biological authentication data.

13. The authentication apparatus according to claim 8, wherein the first program is a BIOS, and the second program is an OS.

14. An authentication program storage medium in which an authentication program is stored, the program being executed in an information processing apparatus for executing programs, and causing the information processing apparatus to operate as an authentication apparatus for performing authentication for two programs which are executed in the information processing apparatus, and the authentication apparatus comprising:
a reference data acquisition section which acquires pre-registered first reference data which is to be the basis of authentication for a first program to be activated earlier between the two programs and pre-registered second reference data to be the basis for authentication for a second program to be activated later between the two programs;
an authentication data acquisition section which acquires authentication data generated by a user operation;
a first authentication section which causes the reference data acquisition section to acquire the first reference data as well as causing the authentication data acquisition section to acquire the authentication data, performs authentication for execution of the first program using the first reference data and the authentication data, and causes the first program to be executed when it is confirmed that a user is an invalid user; and
a second authentication section which causes the reference data acquisition section to acquire the second reference data, performs authentication for execution of the second program using the second reference data and the authentication data already acquired by the authentication data acquisition section, and causes the second program to be executed when it is confirmed that the user is a valid user.

15. The authentication program storage medium according to claim 14, wherein the first and second authentication sections are incorporated in different programs, respectively.

16. The authentication program storage medium according to claim 14, wherein the information processing apparatus is provided with a first and second storage sections, and
the program causes the information processing apparatus to operate as an authentication apparatus, wherein the reference data acquisition section acquires the first reference data stored in the first storage section by reading the first reference data from the first storage section and acquires the second reference data stored in the second storage section by reading the second reference data from the second storage section.

17. The authentication program storage medium according to claim 16, wherein the authentication program causes the information processing apparatus to operate as an authentication apparatus further comprising a reference data registration section which receives reference data to be used as both of the first and second reference data, which is generated by a user operation, and causes both of the first and second storage sections to store the reference data.

18. The authentication program storage medium according to claim 14 wherein the authentication program provides an option of omitting authentication processing and causing each of the first and second programs to be executed,
when the option is set for the first program, the first authentication section skips authentication processing and causes the first program to be executed,
when the option is set for the second program, the second authentication section skips authentication processing and causes the second program to be executed, and
when the option is set only for the first program, the second authentication section causes the reference data acquisition section to acquire the second reference data as well as causing the authentication data acquisition section to acquire the authentication data, performs authentication for execution of the second program using the second reference data and the authentication data, and causes the second program to be executed when it is confirmed that the user is a valid user.

19. The authentication program storage medium according to claim 14, wherein the first and second reference data and the authentication data are biological authentication data.

20. The authentication program storage medium according to claim 14, wherein the first program is a BIOS, and the second program is an OS.

21. An authentication method for performing authentication for two programs which are executed when it is confirmed by authentication that a user is a valid user, the method comprising:
a first step which, when authentication is performed for a first program to be activated earlier between the two programs, acquires pre-registered first reference data which is to be the basis of authentication for the first program as well as acquiring authentication data inputted by the user when authentication is performed for the first program, performs authentication for execution of the first program using the first reference data and the authentication data, and causes the first program to be executed if the user is a valid user; and
a second step which causes, for authentication for a second program to be activated later between the two programs, the authentication data inputted by the user when authentication is performed for the first program to be stored in a storage place referred to when authentication is performed for the second program.

22. An authentication apparatus for performing authentication for two programs which are executed in an information processing apparatus for executing programs, the authentication apparatus comprising:
a reference data acquisition section which acquires pre-registered first reference data which is to be the basis of authentication for a first program to be activated earlier between the two programs and pre-registered second reference data to be the basis of authentication for a second program to be activated later between the two programs;
an authentication data acquisition section which acquires authentication data generated by a user operation; and
a first authentication section which causes the reference data acquisition section to acquire the first reference data as well as causing the authentication data acquisition section to acquire the authentication data, performs authentication for execution of the first program using the first reference data and the authentication data, and causes the first program to be executed when it is confirmed that a user is a valid user,
wherein when the confirmation is obtained, the first authentication section stores, for the second authentication section for performing authentication for execution of the second program using the second reference data and causing the second program to be executed when it is confirmed that the user is a valid user, the authentication data in a storage place acquired by the reference data acquisition section for the second authentication section.

23. An authentication program storage medium in which an authentication program is stored, the program being executed in an information processing apparatus for executing programs, and causing the information processing apparatus to operate as an authentication apparatus for performing authentication for two programs which are executed in the information processing apparatus, and the authentication apparatus comprising:
a reference data acquisition section which acquires pre-registered first reference data which is to be the basis of authentication for a first program to be activated earlier between the two programs and pre-registered second reference data to be the basis for authentication for a second program to be activated later between the two programs;
an authentication data acquisition section which acquires authentication data generated by a user operation; and
a first authentication section which causes the reference data acquisition section to acquire the first reference data as well as causing the authentication data acquisition section to acquire the authentication data, performs authentication for execution of the first program using the first reference data and the authentication data, and causes the first program to be executed when it is confirmed that a user is an invalid user,
wherein when the confirmation is obtained, the first authentication section stores, for the second authentication section for performing authentication for execution of the second program using the second reference data and causing the second program to be executed when it is confirmed that the user is a valid user, the authentication data in a storage place acquired by the reference data acquisition section for the second authentication section.
